(19) United States
(12) Patent Application Publication
(10) Pub. No.: US 2003/0041488 A1
(43) Pub. Date: Mar. 6, 2003

(54) Photo pin

(76) Inventor: William Wu, San Juan Capistrano, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/883,055

(22) Filed: Jun. 14, 2001

(51) Int. Cl. A44C 3/00; G09F 3/08

(52) U.S. Cl. 40/1.6; 40/662; 40/768; 40/798

(57) ABSTRACT

A pin has a front side having a recess therein and a back side having a connector for attaching the pin to an article of clothing. The recess is capable of having a photograph attached therein. The pin provides users of pins with flexibility in designing pins to personal taste. In another version the pin has two hinged sections that can be opened and closed like a book, with each section having a recess for a photo.

### FIELD OF THE INVENTION

The present invention relates to decorative pins that are attachable to clothing and personal belongings for a fashion, recreation, business, or the like.

### BACKGROUND OF THE INVENTION

The front side of a pin to be secured to a person's clothing traditionally displays a sports logo, graphic design, or other artistic component. These traditional pins are normally fixed to one appearance and are impersonal in the sense that the purchasers or wearers of the pin cannot conveniently customize the pin. A pin is desired to provide pin wearers more flexibility to personalize a pin design.

### SUMMARY OF THE INVENTION

Briefly stated, the pin of the invention has a front side with a recess formed therein which is configured to receive a photograph. This creates an attractive frame or border around the photo placed in the recess. The back side of the pin has a post or other connector suitable for attachment to an article of clothing or other material.

In another embodiment of the invention, the pin has a front section and a back section joined by a hinge or other suitable connector that allows the sections to be closed or opened. The surfaces of the sections that face each other when the pin is closed can each be provided with a recess for receiving a photograph. When the sections are opened, the photos are then visible. The back section is adapted for connection to the wearer's clothing. The outer surface of the front section can be provided with whatever decorative appearance is desired.

A method of the invention includes the steps of providing a pin, attaching a photo to the recess, and attaching the pin to a user's clothing.

### BRIEF DESCRIPTION OF THE DRAWINGS

FIG. 1 illustrates the front side of a pin having a recess designed to receive a photograph.

FIG. 2 is an exploded view of the pin of FIG. 1 receiving a photograph.

FIG. 3 illustrates the back side of a pin having a connector for attaching the pin to an article.

FIG. 4 illustrates a pin having two hinged sections in a closed position.

FIG. 5 illustrates the picture receiving sides of the pin of FIG. 4.

FIG. 6 illustrates the other sides of the two sections of the pin illustrated in FIG. 4.

### DETAILED DESCRIPTION OF THE PREFERRED EMBODIMENT

Referring first to FIGS. 1-3, there is illustrated a pin 100 having a front side 102 with a recess 104 therein surrounded by a frame or border 108 having text 106 positioned thereon. Also shown is a border graphic 109 with a pictorial graphic 110 thereon. The recess 104 is adapted or configured to receive a photo to customize the pin. The photo can be a picture of a person, an object, painting, scenery and any other such visual presentation that the user may desire.

In one embodiment, the front side 102 includes only the recess 104 and the border 108 so that the wearer of the pin can completely customize the look and feel of the pin. Alternatively, the pin can include the pre-selected text or graphics illustrated on the border of the pin.

The display text 106 can be an advertisement, a logo such as, for example, a sports team, geographical location, a greeting, an association, and the like. The border graphic 109 can be any design of a desired shape or size of reasonable proportion to the pin, such as for example, a hat, as illustrated. The pictorial graphic 110 can likewise be any artistic design or text, such as for example, the symbol of a sports team.

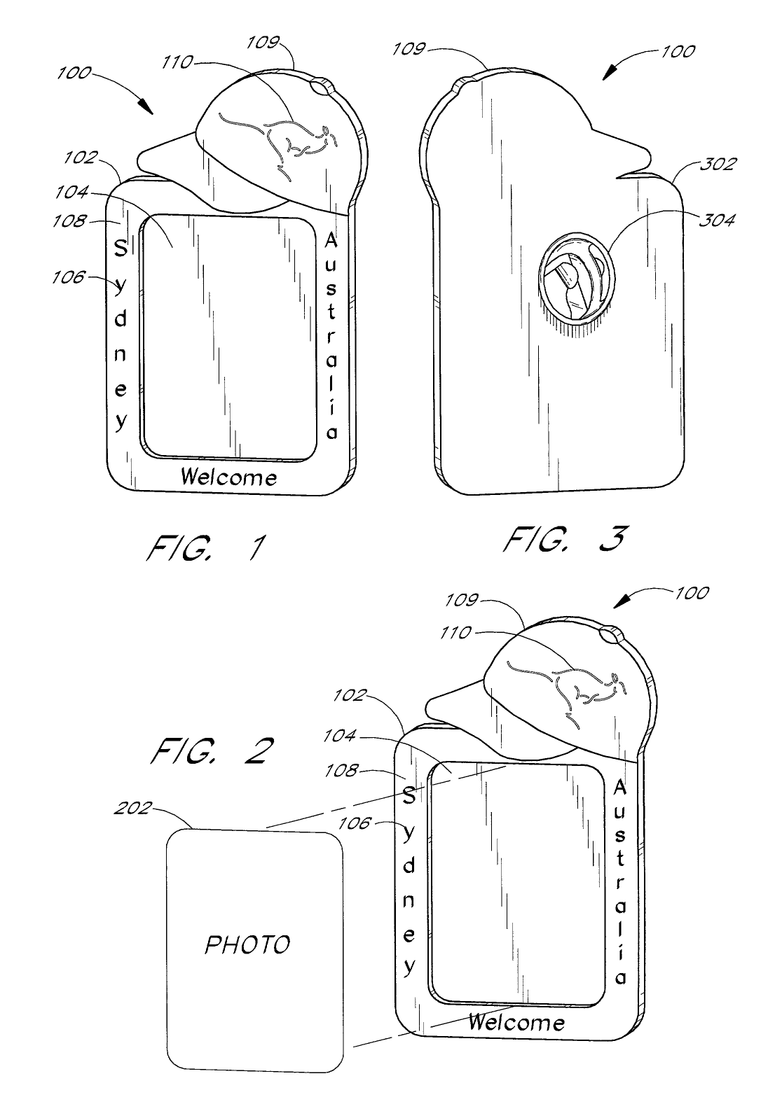

The photo 202 shown in FIG. 2 can be attached to the recess by using any sufficient method known in the art. For example, the photo may be attached by adhesive, a Velcro fastener, or other suitable connector.

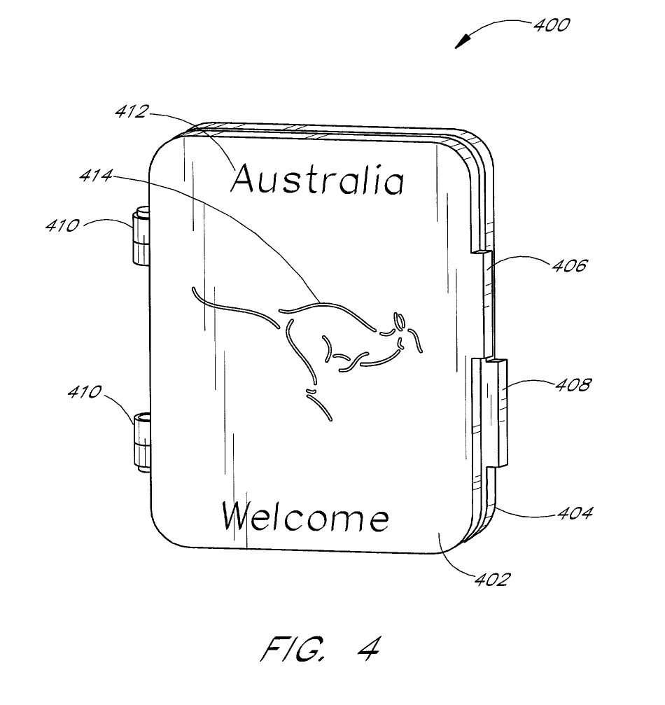

As seen in FIG. 3, a connector in the form of a post 304 extends from the back side 302 of the pin and is adapted to extend to or through material such as articles of clothing, book bags, carrying cases, pocketbooks, and the like. Other suitable connectors can be employed such as a pin and connection piece, adhesive, a Velcro fastener, and any other suitable connector.

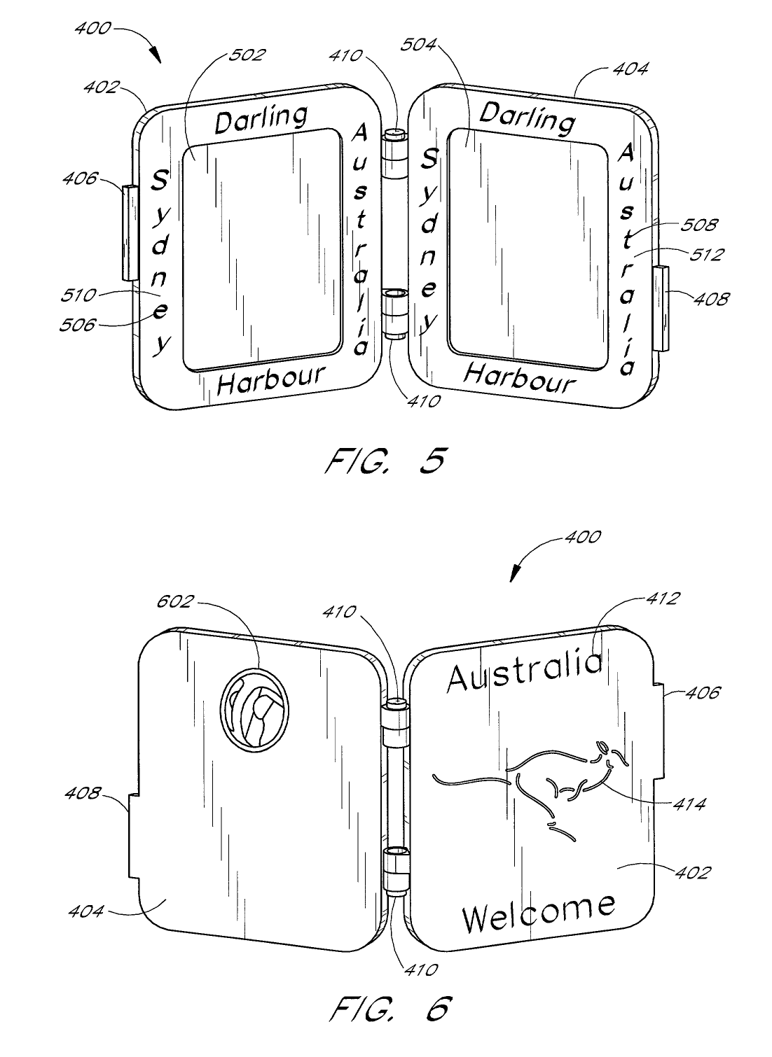

FIGS. 4-6 illustrate a pin 400 having a front section 402 and a back section 404 connected by a hinge 110 or other suitable coupling that enables the sections to be in the closed position of FIG. 4 or in the open position of FIGS. 4 and 5. Section 402 has a tab 406 on the edge opposite the hinge, and back section 404 has a similar tab 408 on the edge opposite the hinge. These tabs can be engaged by the fingers to facilitate opening the pin sections. Of course other opening mechanisms may be employed. The hinge construction 410 is preferably made such that the pin will remain in the selected position without a separate mechanism to hold it open or a latch to hold it closed.

As seen in FIG. 5, the inner sides of the sections that face each other when the pin is closed have a recess for receiving a photo as in the arrangement of FIG. 1. More specifically, the front section has a recess 502 surrounded by a border or frame 510 and the back section 404 has a recess 504 surrounded by a border or frame 512. Display text is shown positioned on the border 510 and display text 508 is shown on the border 512.

Similarly, the front section 402 may be provided with display text 412 or a display pictorial 414 on its outer surface. In an alternative arrangement, the display text 412 and the pictorial 414 can be placed on the pin as stickers by the user of the pin.

Referring to FIG. 6, the back side of the back section 404 can be provided with a connector 602 similar to the connector 304 shown in FIG. 3.

Although this invention has been described in terms of certain preferred embodiments, other arrangements that are apparent to those of ordinary skill in the art are also with in the scope of the invention as defined by reference to the appended claims.

What is claimed is:

1. A pin comprising:
a front side having a recess therein configured to receive a photo therein, said side having a border forming a frame for the photo;
a back side having a connector for attaching the pin to clothing or other attire.

2. The pin of claim 1, further comprising at least one graphic representation on the border.

3. A pin comprising:
a first section having a front and a back side, the back side having a connector for connecting the pin to an article, the front side having a recess for securing a photograph therein; and
a second section connected to the first section in a manner that enables the sections to be moved from a closed position in which the inner sides of the sections are in face-to-face relation, and an open position wherein the inner sides are exposed.

4. The pin of claim 3, wherein the second section has a recess for securing a photograph therein.

5. The pin of claim 4, including a border surrounding each of the recesses for framing the photo to be placed in the recesses.

6. The pin of claim 5, wherein the borders have at least one graphic representation formed thereon.

7. A method comprising:
attaching a photograph to a recess in the front side of a pin which has an attachment member on a back side that can be used to attach the pin to an article.
